(19) United States
(12) Patent Application Publication
(10) Pub. No.: US 2022/0114390 A1
(43) Pub. Date: Apr. 14, 2022

(54) LIVE EVENT CONTEXT BASED CROWD NOISE GENERATION

(71) Applicant: International Business Machines Corporation, Armonk, NY (US)

(72) Inventors: Aaron K. Baughman, Cary, NC (US); Jeffrey D. Amsterdam, Roswell, GA (US); Stephen C. Hammer, Marietta, GA (US)

(73) Assignee: International Business Machines Corporation, Armonk, NY (US)

(21) Appl. No.: 17/070,394

(22) Filed: Oct. 14, 2020

(51) Int. Cl. G06K 9/62; G06N 3/04; G06N 3/08; G10L 13/04; G10L 19/16

(52) U.S. Cl. CPC G06K 9/6257; G06N 3/0454; G10L 19/167; G06K 9/6232; G10L 13/04; G06N 3/08

(57) ABSTRACT

Event data and event participant data corresponding to a time during an event are encoded into a multidimensional feature vector using a trained encoder network. Using an attention mask, the multidimensional feature vector is adjusted, the adjusting amplifying a portion of the multidimensional feature vector according to an importance level of the portion. The adjusted multidimensional feature vector is decoded into an excitement level score using a trained decoder network. Using the excitement level score and a trained neural network model, a frequency and an amplitude of simulated crowd noise corresponding to the time during the event are generated.

### BACKGROUND

The present invention relates generally to a method, system, and computer program product for crowd noise generation. More particularly, the present invention relates to a method, system, and computer program product for live event context based crowd noise generation.

Live events with spectators include sports, music performances, theater performances, and the like. In a physical event, performers perform and interact with each other in person, although the event itself is often transmitted to a remote audience. In a virtual event, performers perform and interact with each other via a two-way communications network such as the Internet, and the event is transmitted to a remote audience.

### SUMMARY

The illustrative embodiments provide a method, system, and computer program product. An embodiment includes a method that encodes, into a multidimensional feature vector using a trained encoder network, event data and event participant data corresponding to a time during an event. An embodiment adjusts, using an attention mask, the multidimensional feature vector, the adjusting amplifying a portion of the multidimensional feature vector according to an importance level of the portion. An embodiment decodes, into an excitement level score using a trained decoder network, the adjusted multidimensional feature vector. An embodiment generates, using the excitement level score and a trained neural network model, a frequency and an amplitude of simulated crowd noise corresponding to the time during the event.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for live event context based crowd noise generation in accordance with an illustrative embodiment;

FIG. 4 depicts a block diagram of an example configuration for live event context based crowd noise generation in accordance with an illustrative embodiment;

FIG. 5 depicts a block diagram of an example configuration for live event context based crowd noise generation in accordance with an illustrative embodiment;

FIG. 6 depicts an example of live event context based crowd noise generation in accordance with an illustrative embodiment;

FIG. 7 depicts another example of live event context based crowd noise generation in accordance with an illustrative embodiment;

FIG. 8 depicts a continued example of live event context based crowd noise generation in accordance with an illustrative embodiment;

FIG. 9 depicts a continued example of live event context based crowd noise generation in accordance with an illustrative embodiment;

FIG. 10 depicts a continued example of live event context based crowd noise generation in accordance with an illustrative embodiment;

FIG. 11 depicts a flowchart of an example process for live event context based crowd noise generation in accordance with an illustrative embodiment;

FIG. 12 depicts a cloud computing environment according to an embodiment of the present invention; and

FIG. 13 depicts abstraction model layers according to an embodiment of the present invention.

### DETAILED DESCRIPTION

The illustrative embodiments recognize that physical events typically include on-site spectators, whose applause, cheers, laughter, boos, and other reactions enhance the event experience for both performers and spectators. Thus, when on-site spectators cannot be present, or are present only at particular portions of the event (e.g. only certain golf holes) or in limited numbers (e.g., due to event capacity restrictions or inclement weather), the event experience can feel abnormal. Players gain motivation and feedback from the appreciation such spectators provide for a particularly good performance (e.g., laughing at a comedian, applause for a well-executed song, cheers when a home sports team scores). The lack of on-site spectators also affects the remote audience, to whom a performance without crowd noise seems flat or boring.

The illustrative embodiments also recognize that virtual events, by their nature, typically lack the feedback provided by spectators. Virtual events are not typically performed for an on-site crowd, and feedback from a remote audience is not incorporated for transmission to performers or other spectators.

The illustrative embodiments also recognize that crowd noise can be generated automatically and incorporated into a performance transmitted to a remote audience. However, generated crowd noise lacks context, not incorporating real spectators' biases for particular performers, teams, performance phases, and the like. For example, cheers when a home sports team scores are likely to be louder and last longer when the scoring wins the team a championship than during the regular season. As another example, when two well-known rival performers compete in a virtual event, such as an electronic game or e-game simulating a physical sport, fans of each performer are likely to be more excited, and hence react more loudly, than if two unknown newcomers were competing. Thus, the illustrative embodiments recognize that there is an unmet need to generate crowd noise for both physical and virtual events, that takes context and real spectators biases into account when incorporated into transmissions of those events.

The illustrative embodiments recognize that the presently available tools or solutions do not address these needs or provide adequate solutions for these needs. The illustrative embodiments used to describe the invention generally address and solve the above-described problems and other problems related to live event context based crowd noise generation.

An embodiment can be implemented as a software application. The application implementing an embodiment can be configured as a modification of an existing live performance transmission system, as a separate application that operates in conjunction with an existing live performance transmission system, a standalone application, or some combination thereof.

Particularly, some illustrative embodiments provide a method that encodes event data and event participant data corresponding to a time during an event into a feature vector, amplifies a portion of the feature vector according to an importance level of the portion, decodes the feature vector into an excitement level score, and uses the excitement level score to generate simulated crowd noise corresponding to the time during the event.

An embodiment collects event data and event participant data for use in determining excitement level scores for times during the event. A portion of the event participant data corresponds to a particular time during an event.

Event data is data of the event itself that might be a factor in determining excitement level scores. For example, if the event is a sport, some non-limiting examples of event data might be which portion of the sport is currently occurring (e.g. the first inning or the ninth inning in baseball, an early season game or the last game of a championship series, a last shot as a play period ends in basketball or hockey), how equal the current score is (e.g. whether one team is ahead by a large margin or whether the score is tied late in the game), and where a physical sport is being played (e.g. where a tennis player or golfer has a large local fan following).

Event participant data is data of a participant in the event that might be a factor in determining excitement level scores. For example, if the event is a sport, some non-limiting examples of event participant data might be a player's game, season, and lifetime statistics (e.g. how far and how fast a player has run, how many shots a player has taken, how many errors a player has made, whether a player is on a scoring streak or about to break a record), a rivalry between players, and a player's biographical data (e.g. where a player grew up or was educated).

In one embodiment, event participant data includes spectator data, obtained with spectators' consent. Some non-limiting examples of spectator data include biometric data (e.g. a spectator's heart rate or sweat level), facial expressions (e.g. smiling or angry), voice pitch, loudness, and speaking speed, and eye gaze data (e.g. how long a spectator looks at an event versus somewhere else).

In one embodiment, event participant data includes biometric data of a player, obtained with the player's consent. Some non-limiting examples of biometric data include a player's heart rate, sweat level, and blood oxygen level.

An embodiment collects event data and event participant data from any presently available source. For example, compendia of statistics for particular sports and players are presently available or can be generated as an event or series of events occurs, and physical data of spectators and players is collectible using presently available sensors and sensing techniques.

An embodiment normalizes and standardizes the event data and event participant data. Normalized data has been converted to a common range, for example from −1 to 1. Standardized data has an average of zero and a variance of one if possible. An embodiment assembles the normalized and standardized data into a source vector, a multidimensional feature vector. A feature is an individual measurable property or characteristic of a phenomenon being observed, and a feature vector is an n-dimensional vector (i.e. a set of numerical values) of numerical features representing the phenomenon. Here, the phenomenon is a particular time during an event.

An embodiment uses a trained encoder network to encode the source vector into a second multidimensional feature vector. In particular, the trained encoder network takes, as input, the source vector and produces a second multidimensional feature vector as output. The trained encoder network is a plurality of feed-forward neural networks connected in series with each other, i.e. a set of outputs of one feed-forward neural network is connected to a set of inputs of the next feed-forward neural network. Each network in the series has the same number of dimensions, matching the number of dimensions of the second multidimensional feature vector.

To train the encoder network, an embodiment uses a set of training data comprising a set of feature vectors. Each feature vector is labelled with a level of excitement corresponding to the data of the feature vector. During training, the encoder network includes an additional one-dimensional prediction neural network as the last component in the series of networks, producing a numerical value indicating a level of excitement. Thus, the encoder network learns, by setting weight values within each encoder network component, to associate feature vector data with a corresponding level of excitement. When training has been completed, the additional prediction neural network is removed, and the trained encoder network produces a multidimensional feature vector instead of a level of excitement number.

Another embodiment uses two source vectors, and two trained encoder networks, each encoding a source vector into a multidimensional feature vector. The embodiment combines, or concatenates, the two resulting vectors into one larger vector, by appending one vector to the other. The resulting combined feature vector has double the number of dimensions as each individual source vector. In one embodiment, one source vector includes normalized and standardized event data and event participant data of a physical component of an event, and the other source vector includes normalized and standardized event data and event participant data of a virtual component of the same event. For example, data of a physical component of an event might include data of players who are competing in a physical sport, and data of a virtual component of the same event might include spectator data of spectators who are not collocated with the players but instead are watching a transmission of the event.

An embodiment uses an attention mask to adjust the multidimensional feature vector. The adjustment amplifies one or more portions of the multidimensional feature vector according to an importance level of a portion.

To generate the attention mask, an embodiment trains a neural network model using a set of training vectors, multidimensional feature vectors output from a trained encoder network. Each of the training vectors is labelled with a ranking of an importance level of a portion of the training vector in determining a level of excitement. Thus, during training the model learns to rank portions of an input vector, corresponding to portions of raw input data, according to their importance in determining a level of excitement.

An embodiment includes two configurable parameters: the number of portions of an input vector that should be amplified and the amount of amplification to add. For example, the number of portions to be amplified might be set to fifty, indicating that the top fifty input vector portions should be adjusted. The amount of amplification to add is a percentage. For example, an amount of amplification set to ten percent indicates that each of the most important input vector portions should be multiplied by 1.10. In embodiments, the configurable parameters are preset to constants, user-configurable, or user-configurable with preset defaults.

Thus, during use an embodiment inputs a multidimensional feature vector, output from the trained encoder network, to the trained model. The trained model produces an output ranking portions of the vector by their importance. An embodiment uses the output to generate an attention mask that, when multiplied by the feature vector, amplifies the set of most important portions of the feature vector by the amount of amplification, producing an adjusted feature vector.

An embodiment uses a trained decoder network to decode the adjusted feature vector into one or more excitement level scores. In particular, the trained decoder network takes, as input, the adjusted feature vector and produces excitement level scores as output. The trained decoder network is a plurality of feed-forward neural networks connected in series with each other, i.e. a set of outputs of one feed-forward neural network is connected to a set of inputs of the next feed-forward neural network. The first network in the series has the same number of dimensions as the adjusted feature vector, and successive networks in the series have decreasing numbers of dimensions. The last network in the series has a number of dimensions equal to the number of excitement level scores to be produced.

To train the decoder network, an embodiment uses a set of training data comprising a set of feature vectors. Each feature vector is labelled with a set of excitement level scores corresponding to the data of the feature vector. Thus, the decoder network learns, by setting weight values within each decoder network component, to associate feature vector data with a corresponding set of excitement level scores.

One embodiment produces one overall score. Another embodiment produces three excitement level scores: an overall score (for an entire audience), an individual score (for a particular individual within the audience), and a group score (for a group of similar people within the audience). Another embodiment, in which one source vector includes data of a physical component of an event, and the other source vector includes data of a virtual component of the same event, produces nine excitement level scores: an overall score, an individual score, and a group score for each of the physical component, the virtual component, and the overall event.

An embodiment uses one or more excitement level scores and a trained neural network model to generate a frequency and an amplitude of simulated crowd noise corresponding to an input excitement level score. In one embodiment, the neural network model includes an input layer, one or more hidden layers, and an output layer; other implementations are also possible and contemplated within the scope of the illustrative embodiments. In one embodiment, each input in the input layer corresponds to an excitement level score.

To train the neural network model, an embodiment uses training data comprising group and individual excitement level scores, each labelled with a corresponding frequency and an amplitude of simulated crowd noise. Thus, the model learns to generate a frequency and an amplitude of simulated crowd noise corresponding to an input excitement level score.

One embodiment generates one frequency value and amplitude value for a set of input excitement level scores, and outputs simulated crowd noise corresponding to the frequency and amplitude values. Another embodiment generates one frequency value and amplitude value for each of a set of input excitement level scores, outputs simulated crowd noise components corresponding to each frequency and amplitude value, and constructively combines the simulated crowd noise components into one final output.

The manner of live event context based crowd noise generation described herein is unavailable in the presently available methods in the technological field of endeavor pertaining to content transmission to a remote audience. A method of an embodiment described herein, when implemented to execute on a device or data processing system, comprises substantial advancement of the functionality of that device or data processing system in encoding event data and event participant data corresponding to a time during an event into a feature vector, amplifying a portion of the feature vector according to an importance level of the portion, decoding the feature vector into an excitement level score, and using the excitement level score to generate simulated crowd noise corresponding to the time during the event.

The illustrative embodiments are described with respect to certain types of events, event data, event participant data, biometric data, training data, neural networks, models, vectors, scores, encoder networks, decoder networks, masks, rankings, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

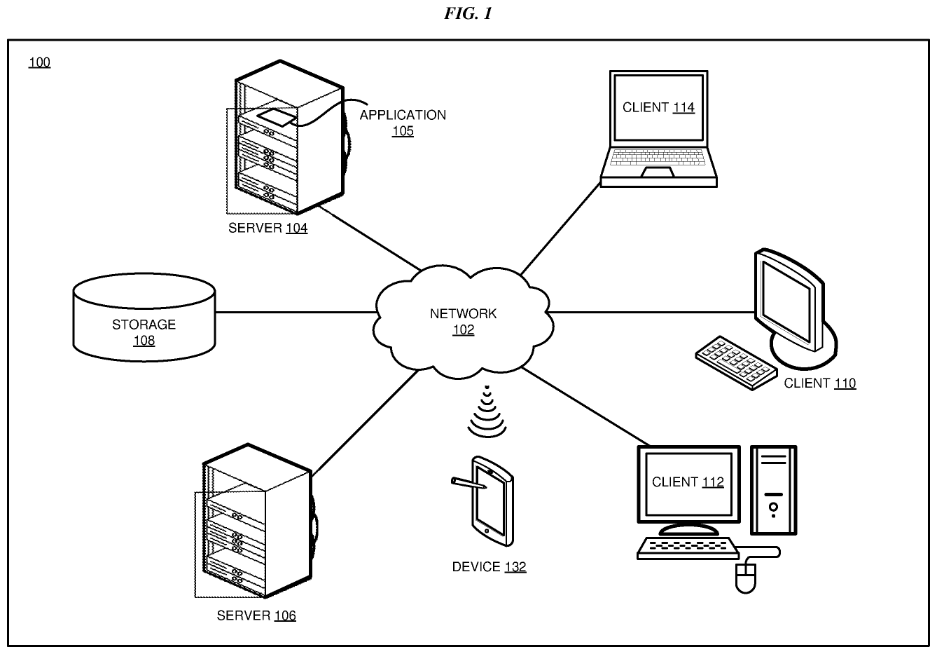

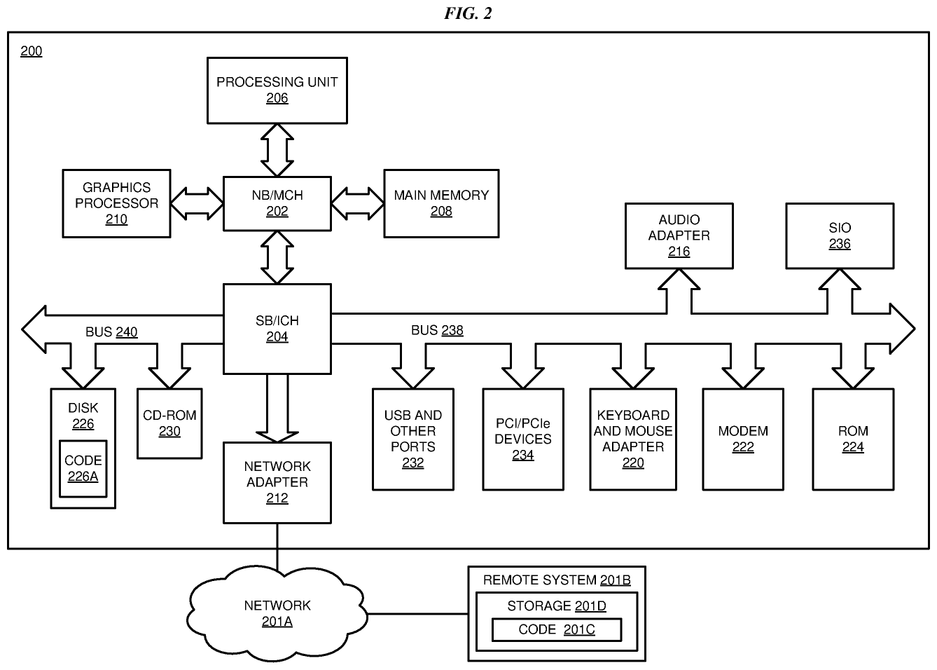

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

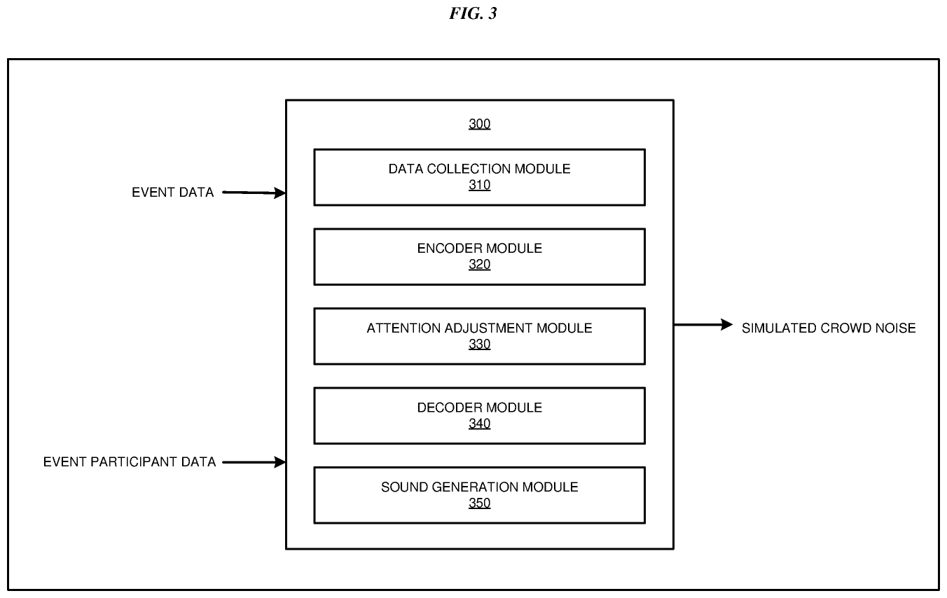

With reference to FIG. 3, this figure depicts a block diagram of an example configuration for live event context based crowd noise generation in accordance with an illustrative embodiment. Application 300 is an example of application 105 in FIG. 1 and executes in any of servers 104 and 106, clients 110, 112, and 114, and device 132 in FIG. 1.

Data collection module 310 collects event data and event participant data for use in determining excitement level scores for times during the event. A portion of the event participant data corresponds to a particular time during an event. In implementations of module 310, event participant data includes spectator data, biometric data of a player, or both. Data collection module 310 also normalizes and standardizes the event data and event participant data.

Encoder module 320 uses a trained encoder network to encode the source vector into a second multidimensional feature vector. In particular, the trained encoder network takes, as input, the source vector and produces a second multidimensional feature vector as output. The trained encoder network is a plurality of feed-forward neural networks connected in series with each other, i.e. a set of outputs of one feed-forward neural network is connected to a set of inputs of the next feed-forward neural network. Each network in the series has the same number of dimensions, matching the number of dimensions of the second multidimensional feature vector.

To train the encoder network, module 320 uses a set of training data comprising a set of feature vectors. Each feature vector is labelled with a level of excitement corresponding to the data of the feature vector. During training, the encoder network includes an additional one-dimensional prediction neural network as the last component in the series of networks, producing a numerical value indicating a level of excitement. Thus, the encoder network learns, by setting weight values within each encoder network component, to associate feature vector data with a corresponding level of excitement. When training has been completed, the additional prediction neural network is removed, and the trained encoder network produces a multidimensional feature vector instead of a level of excitement number.

Another implementation of module 320 uses two source vectors, and two trained encoder networks, each encoding a source vector into a multidimensional feature vector. The implementation combines, or concatenates, the two resulting vectors into one larger vector, by appending one vector to the other. The resulting combined feature vector has double the number of dimensions as each individual source vector. In one implementation of module 320, one source vector includes normalized and standardized event data and event participant data of a physical component of an event, and the other source vector includes normalized and standardized event data and event participant data of a virtual component of the same event.

Attention adjustment module 330 uses an attention mask to adjust the multidimensional feature vector. The adjustment amplifies one or more portions of the multidimensional feature vector according to an importance level of a portion.

To generate the attention mask, module 330 trains a model such as a neural network using a set of training vectors, multidimensional feature vectors output from a trained encoder network. Each of the training vectors is labelled with a ranking of an importance level of a portion of the training vector in determining a level of excitement. Thus, during training the model learns to rank portions of an input vector, corresponding to portions of raw input data, according to their importance in determining a level of excitement.

Module 330 includes two configurable parameters: the number of portions of an input vector that should be amplified and the amount of amplification to add. For example, the number of portions to be amplified might be set to fifty, indicating that the top fifty input vector portions should be adjusted. The amount of amplification to add is a percentage. For example, an amount of amplification set to ten percent indicates that each of the most important input vector portions should be multiplied by 1.10. In implementations of module 330, the configurable parameters are preset to constants, user-configurable, or user-configurable with preset defaults.

Thus, during use module 330 inputs a multidimensional feature vector, output from the trained encoder network, to the trained model. The trained model produces an output ranking portions of the vector by their importance. Module 330 uses the output to generate an attention mask that, when multiplied by the feature vector, amplifies the set of most important portions of the feature vector by the amount of amplification, producing an adjusted feature vector.

Decoder module 340 uses a trained decoder network to decode the adjusted feature vector into one or more excitement level scores. In particular, the trained decoder network takes, as input, the adjusted feature vector and produces one or more excitement level scores as output. The trained decoder network is a plurality of feed-forward neural networks connected in series with each other, i.e. a set of outputs of one feed-forward neural network is connected to a set of inputs of the next feed-forward neural network. The first network in the series has the same number of dimensions as the adjusted feature vector, and successive networks in the series have decreasing numbers of dimensions. The last network in the series has a number of dimensions equal to the number of excitement level scores to be produced.

To train the decoder network, module 340 uses a set of training data comprising a set of feature vectors. Each feature vector is labelled with a set of excitement level scores corresponding to the data of the feature vector. Thus, the decoder network learns, by setting weight values within each decoder network component, to associate feature vector data with a corresponding set of excitement level scores.

One implementation of module 340 produces one overall score. Another implementation of module 340 produces three excitement level scores: an overall score, an individual score, and a group score. Another implementation of module 340, in which one source vector includes data of a physical component of an event, and the other source vector includes data of a virtual component of the same event, produces nine excitement level scores: an overall score, an individual score, and a group score for each of the physical component, the virtual component, and the overall event.

Sound generation module 350 uses one or more excitement level scores and a trained neural network model to generate a frequency and an amplitude of simulated crowd noise corresponding to an input excitement level score. In one implementation of module 350, the neural network model includes an input layer, one or more hidden layers, and an output layer; other implementations are also possible and contemplated within the scope of the illustrative embodiments. In one implementation of module 350, each input in the input layer corresponds to an excitement level score.

To train the neural network model, module 350 uses training data comprising sets of excitement level scores, each labelled with a label. Thus, the model learns to generate a frequency and an amplitude of simulated crowd noise corresponding to an input excitement level score.

One implementation of module 350 generates one frequency value and amplitude value for a set of input excitement level scores, and outputs simulated crowd noise corresponding to the frequency and amplitude values. Another implementation of module 350 generates one frequency value and amplitude value for each of a set of input excitement level scores, outputs simulated crowd noise components corresponding to each frequency and amplitude value, and constructively combines the simulated crowd noise components into one final output.

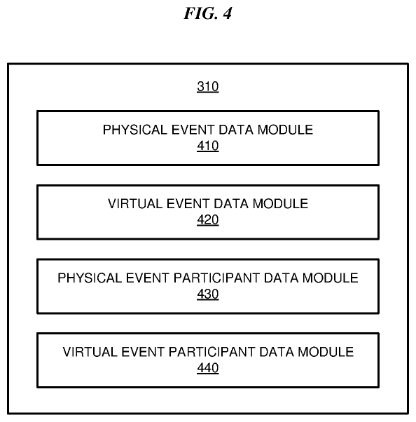

With reference to FIG. 4, this figure depicts a block diagram of an example configuration for live event context based crowd noise generation in accordance with an illustrative embodiment. In particular, FIG. 4 depicts more detail of module 310 in FIG. 3.

FIG. 4 depicts an implementation of module 310 that collects, normalizes, and standardizes event data and event participant data of a physical component of an event, and a virtual component of the same event. In particular, physical event data module 410 processes event data of the physical component and virtual event data module 420 processes event data of the virtual component. Physical event participant data module 430 processes event participant data of the physical component and virtual event participant data module 440 processes event participant data of the virtual component.

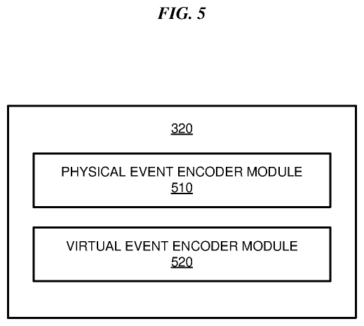

With reference to FIG. 5, this figure depicts a block diagram of an example configuration for live event context based crowd noise generation in accordance with an illustrative embodiment. In particular, FIG. 5 depicts more detail of module 320 in FIG. 3.

FIG. 5 depicts an implementation of module 320 that uses two source vectors, and two trained encoder networks, each encoding a source vector into a multidimensional feature vector. In particular, physical event encoder module 510 encodes data of a physical component of an event into a feature vector, and virtual event encoder module 520 encodes data of a virtual component of an event into a feature vector. Module 320 combines, or concatenates, the two resulting vectors into one larger vector, by appending one vector to the other. The resulting combined feature vector has double the number of dimensions as each individual source vector.

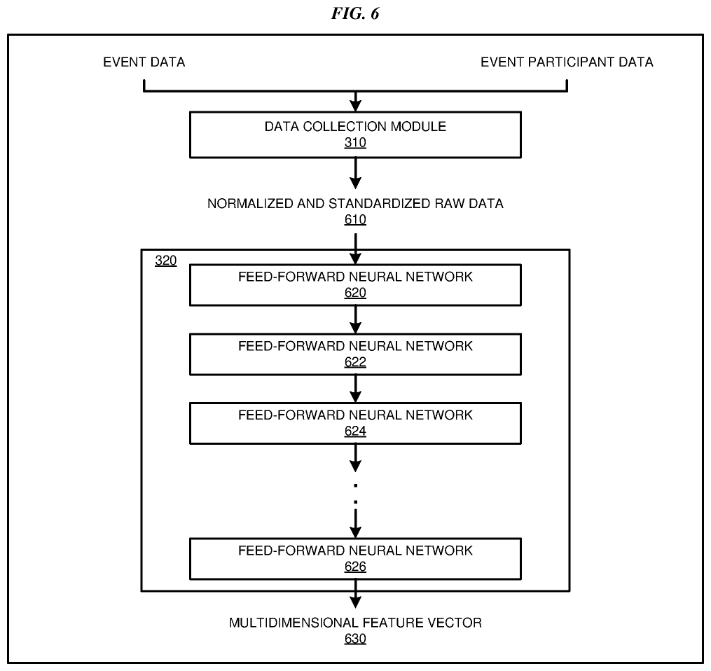

With reference to FIG. 6, this figure depicts an example of live event context based crowd noise generation in accordance with an illustrative embodiment. The example can be executed using application 300 in FIG. 3. Data collection module 310 and encoder module 320 are the same as data collection module 310 and encoder module 320 in FIG. 3.

As depicted, data collection module 310 collects event data and event participant data for use in determining excitement level scores for times during the event, and normalizes and standardizes the data, producing normalized and standardized raw data 610. Encoder module 320 uses a trained encoder network to encode data 610 into a multidimensional feature vector 630. In particular, the trained encoder network includes feed forward neural networks 620, 622, 624, and 626 connected in series with each other. Each network in the series has the same number of dimensions, matching the number of dimensions of the multidimensional feature vector 630.

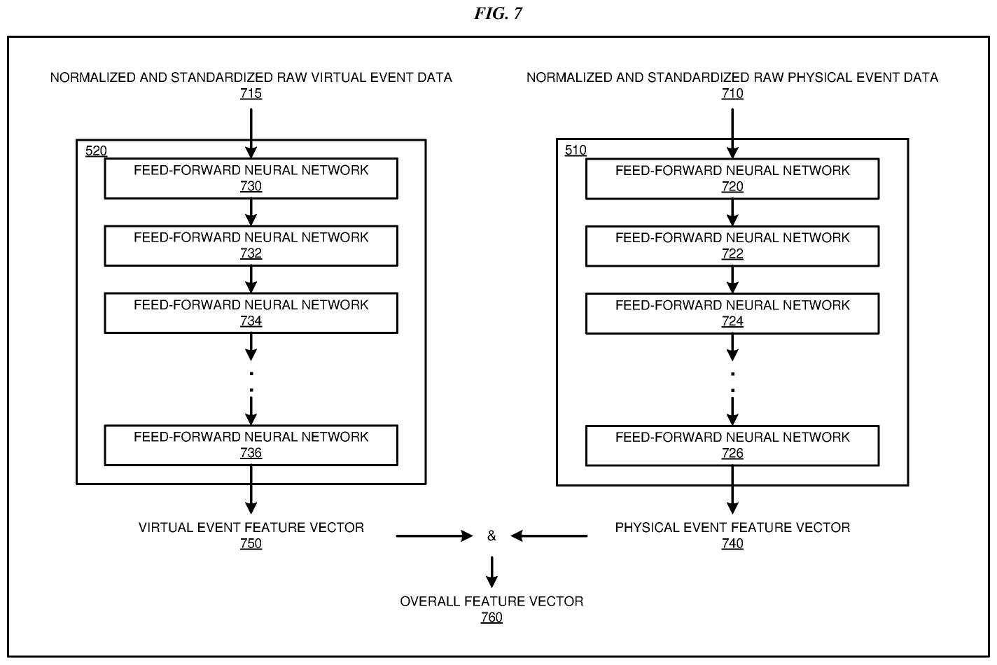

With reference to FIG. 7, this figure depicts another example of live event context based crowd noise generation in accordance with an illustrative embodiment. The example can be executed using application 300 in FIG. 3. Physical event encoder module 510 and virtual event encoder module 520 are the same as physical event encoder module 510 and virtual event encoder module 520 in FIG. 5.

As depicted, physical event encoder module 510 takes, as input, normalized and standardized raw physical event data 710. Virtual event encoder module 520 takes, as input, normalized and standardized raw virtual event data 715. Module 510 uses a trained encoder network to encode data 710 into physical feature vector 740. In particular, the trained encoder network includes feed forward neural networks 720, 722, 724, and 726 connected in series with each other. Each network in the series has the same number of dimensions, matching the number of dimensions of the multidimensional feature vector 740. Module 520 uses a second trained encoder network to encode data 715 into virtual feature vector 750. In particular, the second trained encoder network includes feed forward neural networks 730, 732, 734, and 736 connected in series with each other. Each network in the series has the same number of dimensions, matching the number of dimensions of the multidimensional feature vector 750. Finally, vectors 740 and 750 are combined, or concatenated, into overall feature vector 760, by appending vector 750 to vector 740. Vector 760 has double the number of dimensions as each individual source vector.

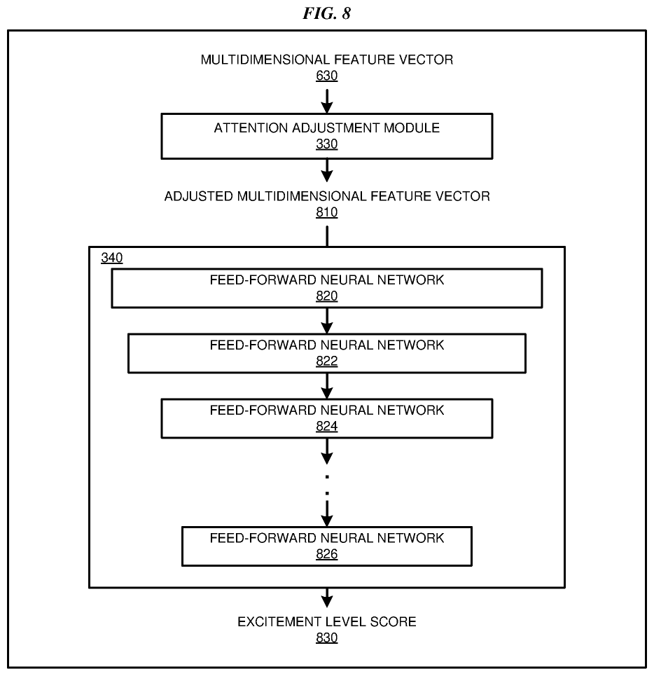

With reference to FIG. 8, this figure depicts a continued example of live event context based crowd noise generation in accordance with an illustrative embodiment. Attention adjustment module 330 and decoder module 340 are the same as attention adjustment module 330 and decoder module 340 in FIG. 3. Multidimensional feature vector 630 is the same as multidimensional feature vector 630 in FIG. 6.

As depicted, attention adjustment module 330 uses an attention mask to adjust multidimensional feature vector 630, amplifying one or more portions of the multidimensional feature vector according to an importance level of a portion. The result is adjusted multidimensional feature vector 810.

Decoder module 340 uses a trained decoder network to decode the adjusted feature vector into one or more excitement level scores. In particular, the trained decoder network takes, as input, vector 810 and produces one or more excitement level scores 830 as output. The trained decoder network includes feed-forward neural networks 820, 822, 824, and 826 connected in series with each other. Network 820, the first network in the series, has the same number of dimensions as vector 810, and successive networks in the series have decreasing numbers of dimensions. The last network in the series, network 826, has a number of dimensions equal to the number of excitement level scores 830 that are produced.

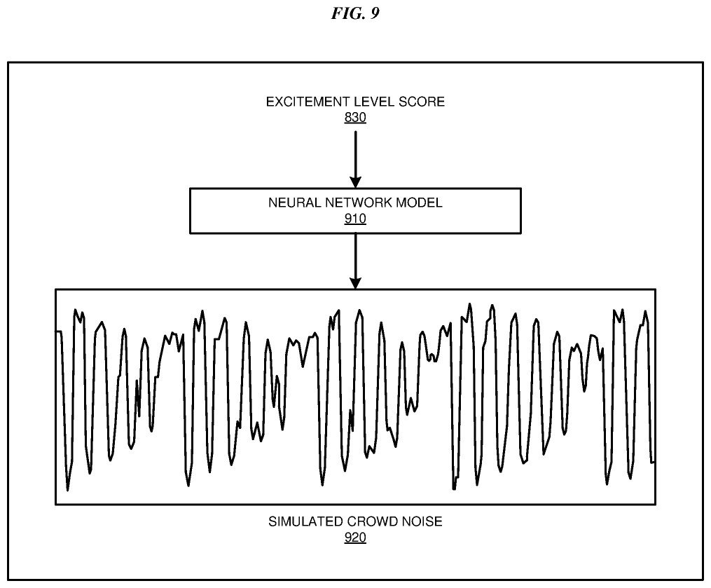

With reference to FIG. 9, this figure depicts a continued example of live event context based crowd noise generation in accordance with an illustrative embodiment. Excitement level score 830 is the same as excitement level score 830 in FIG. 8.

Excitement level score 830 is input to trained neural network model 910, which generates a frequency and an amplitude of points in simulated crowd noise 920 corresponding to score 830.

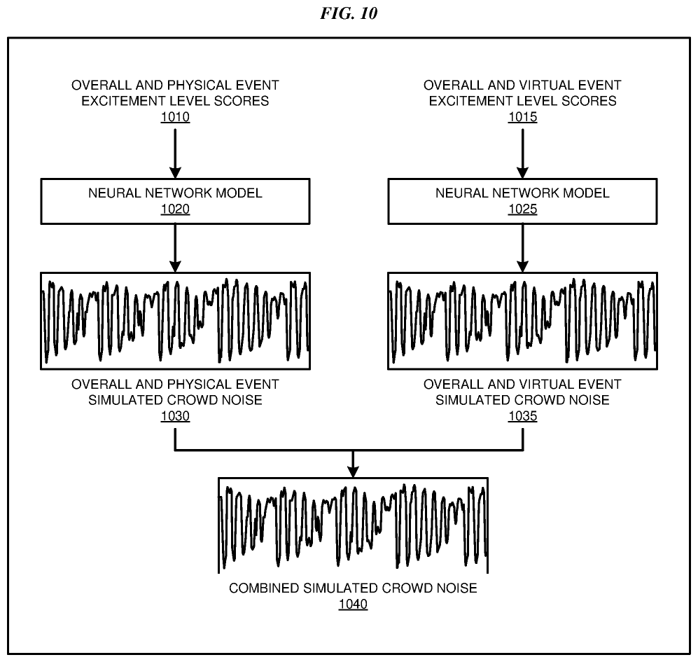

With reference to FIG. 10, this figure depicts a continued example of live event context based crowd noise generation in accordance with an illustrative embodiment.

Overall and physical event level scores 1010 are input to trained neural network model 1020, which generates a frequency and an amplitude of points in overall and physical event simulated crowd noise 1030 corresponding to scores 1010. Overall and virtual event level scores 1015 are input to trained neural network model 1025, which generates a frequency and an amplitude of points in overall and virtual event simulated crowd noise 1035 corresponding to scores 1015. Simulated crowd noise 1030 and 1035 are constructively combined into combined simulated crowd noise 1040.

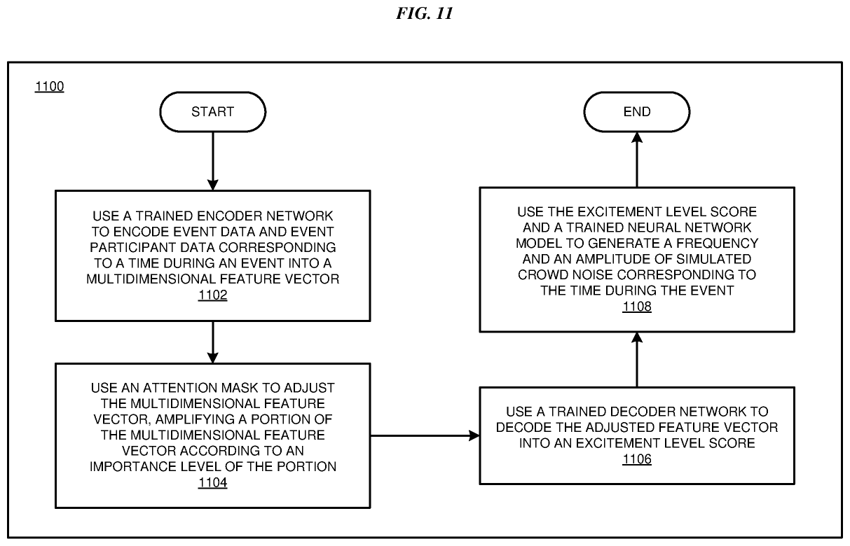

With reference to FIG. 11, this figure depicts a flowchart of an example process for live event context based crowd noise generation in accordance with an illustrative embodiment. Process 1100 can be implemented in application 300 in FIG. 3.

In block 1102, the application uses a trained encoder network to encode event data and event participant data corresponding to a time during an event into a multidimensional feature vector. In block 1104, the application uses an attention mask to adjust the multidimensional feature vector, amplifying a portion of the multidimensional feature vector according to an importance level of the portion. In block 1106, the application uses a trained decoder network to decode the adjusted feature vector into an excitement level score. In block 1108, the application uses the excitement level score and a trained neural network model to generate a frequency and an amplitude of simulated crowd noise corresponding to the time during the event. Then the application ends.

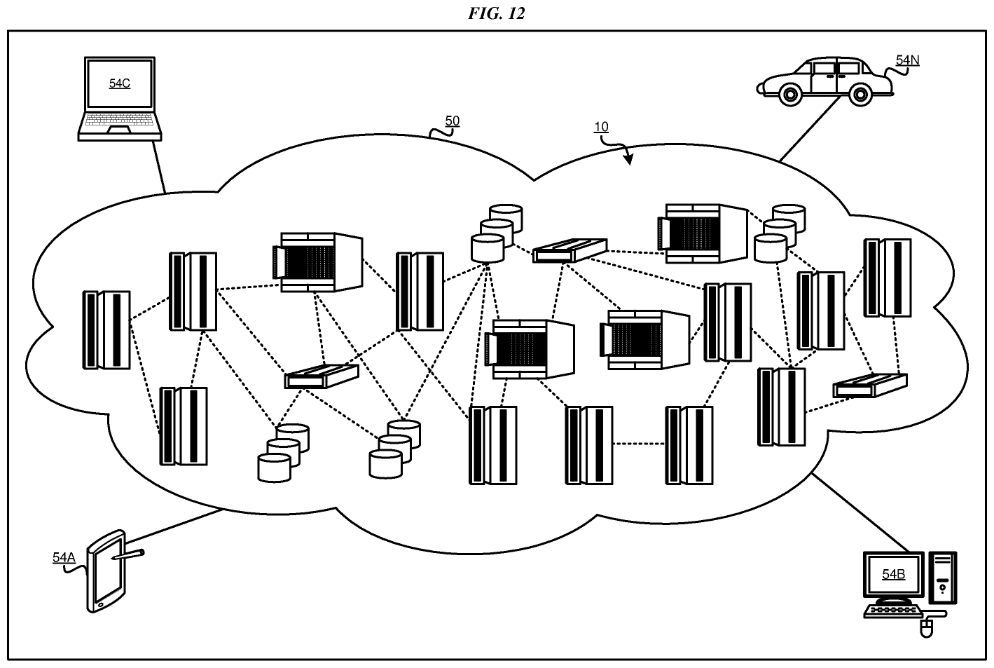

Referring now to FIG. 12, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

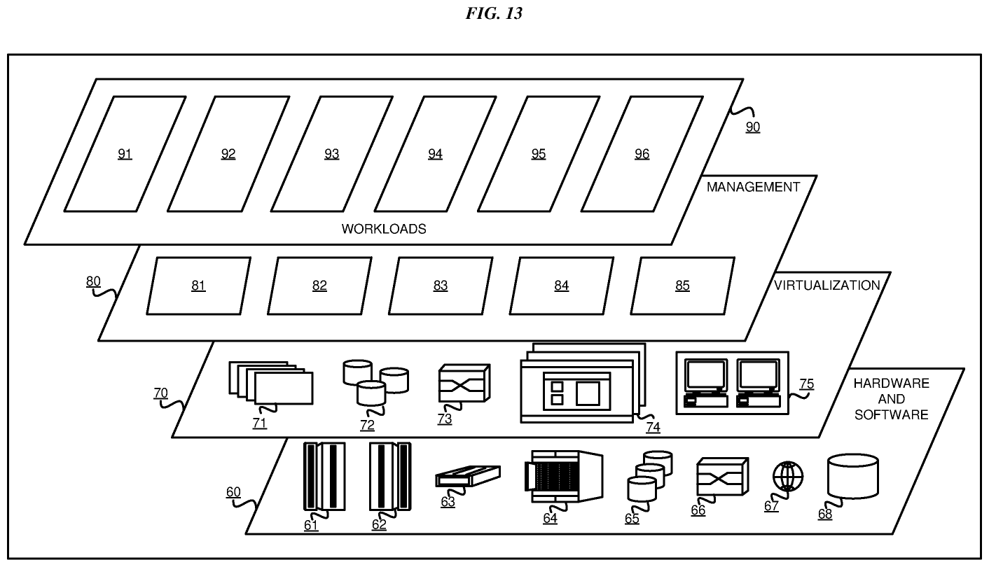

Referring now to FIG. 13, a set of functional abstraction layers provided by cloud computing environment 50 (FIG. 12) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for live event context based crowd noise generation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
encoding, into a multidimensional feature vector using a trained encoder network, event data and event participant data corresponding to a time during an event;
adjusting, using an attention mask, the multidimensional feature vector, the adjusting amplifying a portion of the multidimensional feature vector according to an importance level of the portion;
decoding, into an excitement level score using a trained decoder network, the adjusted multidimensional feature vector; and
generating, using the excitement level score and a trained neural network model, a frequency and an amplitude of simulated crowd noise corresponding to the time during the event.

2. The computer-implemented method of claim 1, wherein the trained encoder network comprises a plurality of feed-forward neural networks connected in series.

3. The computer-implemented method of claim 2, wherein each of the plurality of feed-forward neural networks connected in series has the same dimension.

4. The computer-implemented method of claim 1, wherein the trained encoder network comprises a plurality of trained encoder networks, each encoding a portion of the event data and a portion of the event participant data, each producing an output feature vector, and wherein the multidimensional feature vector comprises the output feature vectors appended to each other.

5. The computer-implemented method of claim 1, wherein the trained decoder network comprises a plurality of feed-forward neural networks connected in series, a dimension of a first feed-forward neural network in the series being equal to a dimension of the adjusted multidimensional feature vector, a dimension of a last feed-forward neural network in the series being equal to a number of excitement level scores.

6. The computer-implemented method of claim 5, wherein a dimension of an intermediate feed-forward neural network in the series is between the dimension of the first feed-forward neural network and the dimension of the last feed-forward neural network.

7. The computer-implemented method of claim 1, wherein each input to the trained neural network model corresponds to an excitement level score.

8. The computer-implemented method of claim 1, wherein the trained neural network model comprises a hidden layer.

9. A computer program product for live event context based crowd noise generation, the computer program product comprising:
one or more computer readable storage media, and program instructions collectively stored on the one or more computer readable storage media, the program instructions comprising:
program instructions to encode, into a multidimensional feature vector using a trained encoder network, event data and event participant data corresponding to a time during an event;
program instructions to adjust, using an attention mask, the multidimensional feature vector, the adjusting amplifying a portion of the multidimensional feature vector according to an importance level of the portion;
program instructions to decode, into an excitement level score using a trained decoder network, the adjusted multidimensional feature vector; and
program instructions to generate, using the excitement level score and a trained neural network model, a frequency and an amplitude of simulated crowd noise corresponding to the time during the event.

10. The computer program product of claim 9, wherein the trained encoder network comprises a plurality of feed-forward neural networks connected in series.

11. The computer program product of claim 10, wherein each of the plurality of feed-forward neural networks connected in series has the same dimension.

12. The computer program product of claim 9, wherein the trained encoder network comprises a plurality of trained encoder networks, each encoding a portion of the event data and a portion of the event participant data, each producing an output feature vector, and wherein the multidimensional feature vector comprises the output feature vectors appended to each other.

13. The computer program product of claim 9, wherein the trained decoder network comprises a plurality of feed-forward neural networks connected in series, a dimension of a first feed-forward neural network in the series being equal to a dimension of the adjusted multidimensional feature vector, a dimension of a last feed-forward neural network in the series being equal to a number of excitement level scores.

14. The computer program product of claim 13, wherein a dimension of an intermediate feed-forward neural network in the series is between the dimension of the first feed-forward neural network and the dimension of the last feed-forward neural network.

15. The computer program product of claim 9, wherein each input to the trained neural network model corresponds to an excitement level score.

16. The computer program product of claim 9, wherein the trained neural network model comprises a hidden layer.

17. The computer program product of claim 9, wherein the stored program instructions are stored in the at least one of the one or more storage media of a local data processing system, and wherein the stored program instructions are transferred over a network from a remote data processing system.

18. The computer program product of claim 9, wherein the stored program instructions are stored in the at least one of the one or more storage media of a server data processing system, and wherein the stored program instructions are downloaded over a network to a remote data processing system for use in a computer readable storage device associated with the remote data processing system.

19. The computer program product of claim 9, wherein the computer program product is provided as a service in a cloud environment.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to encode, into a multidimensional feature vector using a trained encoder network, event data and event participant data corresponding to a time during an event;
program instructions to adjust, using an attention mask, the multidimensional feature vector, the adjusting amplifying a portion of the multidimensional feature vector according to an importance level of the portion;
program instructions to decode, into an excitement level score using a trained decoder network, the adjusted multidimensional feature vector; and
program instructions to generate, using the excitement level score and a trained neural network model, a frequency and an amplitude of simulated crowd noise corresponding to the time during the event.
